(19) United States
(12) Patent Application Publication
(10) Pub. No.: US 2013/0344966 A1
(43) Pub. Date: Dec. 26, 2013

(54) METHOD AND SYSTEM FOR PROVIDING VIDEO GAME CONTENT

(71) Applicant: Zaid I. Mustafa, London (GB)

(72) Inventor: Zaid I. Mustafa, London (GB)

(73) Assignee: Awais I MUSTAFA, London (GB)

(21) Appl. No.: 13/984,444

(22) PCT Filed: Jan. 27, 2012
(86) PCT No.: PCT/GB2012/050172

§ 371 Date: Sep. 4, 2013

(30) Foreign Application Priority Data
Feb. 8, 2011 (GB) 1102128.4

(51) Int. Cl. A63F 13/12

(52) U.S. Cl. CPC A63F 13/12
USPC 463/42

(57) ABSTRACT

Methods of and apparatus for providing video game content to a user of a client device (2), the client device (2) being connected to a remote server (3) via a telecommunications the client device (2); storing moving object data representative of one or more moving objects on the remote server (3); transmitting a signal from the client side (2), the signal comprising data relating to the output of video game content; streaming the moving object data from the remote server (3) to the client device (2) in response to receiving the signal; combining the moving object data and the background data to produce video game content comprising an image in which the one or more objects (50, 60, 250) move; and out-putting the video game content to the user. Adverts can be streamed in addition, potentially targeted by means of a user profile.

The present invention relates to, inter alia, a method and system for providing video game content to a user.

Computer video games for video games consoles are well known in the art. Typically, a video game is provided on a storage medium, such as an optical disk, and sold to consumers at retail outlets. A consumer wishing to play the video game must purchase a copy on a medium which is compatible with their games console. The video game content stored on the medium is loaded into the memory of the console and output to the consumer by means of a display device connected to games console. A user input device, such as a control pad, is typically connected to the console to enable the consumer to input commands and thereby determine the outcome of the video game being played.

A problem exists in that video games can be copied and distributed without the permission of the video game developers and the authorised distributors. For example, if the contents of the storage medium are copied onto one or more additional disks, these may be passed on to consumers, who will not then purchase a copy of the video game from the authorised retail outlet. A significant amount of money is invested in the development of new video games and, therefore, such video game piracy is harmful to the industry.

It is an object of the present invention to provide a method and system for providing video game content to a user which substantially overcomes or mitigates at least some of the aforementioned problems.

According to a first aspect of the invention, there is provided a method of providing video game content to a user of a client device, the client device being connected to a remote server via a telecommunications network, the method comprising:
storing video game background data at the client device;
storing moving object data representative of one or more moving objects on the remote server;
transmitting a signal from the client side, the signal comprising data relating to the output of video game content;
streaming the moving object data from the remote server to the client device in response to receiving the signal;
combining the moving object data and the background data to produce video game content comprising an image in which the one or more objects move; and
outputting the video game content to the user.

Thus, by virtue of the above-described method, video game piracy may be prevented because only part of the video game data required to play the game is stored on the client side. For the game to function correctly, the moving object data must be streamed from the server side via the telecommunications network. The streamed data is not stored on the client side, therefore, even if an unauthorised copy of the background data stored on the client side is made, such a copy is incomplete and therefore of no use to a consumer. Typically, the video game of which the video game data is part will be unplayable without the moving object data.

The client side may comprise the client device.

Furthermore, the moving object data stored on the server side represents only a small portion of the video game content compared to the background data stored on the client side. Accordingly, only a relatively narrow bandwidth connection is required to stream the moving object data over the telecommunications network compared to the bandwidth which would be required to stream the entire video game, comprising background data and moving object data, from a remote server to a client device. Moreover, since the moving object data represents only a relatively small portion of the content of an entire video game, the amount of storage capacity of the remote server can be kept to a minimum, thereby reducing costs.

Additionally, the present method can be used to offload computationally intensive tasks from the client device onto to the server. This can allow more complex games to be played on the client device than otherwise would be the case. This is particularly applicable where the or each moving object is a representation of a three dimensional object. As such, the moving object data may comprise a two-dimensional representation of the or each moving object, and the method may comprise rendering on the remote server the two-dimensional representation, typically from a three-dimensional model.

Where the video game background data comprises a representation of a background on which the or each moving object moves, the step of rendering the two-dimensional representation on the server may comprise rendering reflections from the background on the or each moving object. In such a case, the signal may comprise sufficient information for the remote server to reconstruct the background around the or each moving object.

In one embodiment, the remote server may have its own representation of the background, which may be a copy of the video game background data. Furthermore, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

Equally, with three dimensional videogames, the remote server may still render the reflections on the surface of the moving object; the moving object data will comprise a three-dimensional representation of the moving object with reflections embedded therein.

In a further alternative, the content of a background can be determined at the remote server; the signal would then comprise a list of items used to build up the background. The client device may store, as part of the background data, images of a plurality of possible items from which the items in the list are selected. The signal would typically also include a position, typically three dimensional and so typically comprising lateral, two dimensional position and depth, for each of the items in the list. The client device may, as part of the step of combining the moving object data and the background data, generate the background by overlaying the images corresponding to each of the items in the list in accordance with the position of each of the items. Typically, the depth would be used to decide which image would overlay each other image.

Preferably, the method comprises authenticating the user on the remote server and streaming the moving object data only if the user is successfully authenticated. In one embodiment, this may comprise:
storing first authentication data on the remote server;
transmitting second authentication data together with the signal comprising data relating to the output of video game content;
comparing the first and second authentication data; and
streaming the moving object data from the remote server to the client device in dependence on determining a match between the first and second authentication data.

More preferably, said first and second authentication data comprise at least one of an IP address, a Media Access Control (MAC) address, a username and a user account password.

The step of authenticating the user may comprise determining a successful authentication of the user for a period of time dependent upon the user having paid a fee.

The step of authenticating the user may comprise determining whether the user is permitted to access a particular subset of the moving object data indicated by the signal. As such, the user may only be permitted to access certain parts of a particular game. Access to other subsets of the moving object data may be permitted once the user has completed a certain part of the game, or has paid a fee.

Preferably, the method comprises:
storing data relating to a user's progress through a video game on the remote server and on the client device in response to a break in connection between the remote server and the client device; and
when the connection is re-established, combining the moving object data and the background data in dependence on the data relating to a user's progress so as to resume the video game from the point at which the connection was broken. Preferably, the method comprises:
storing data relating to a user's progress through a video game on one of the remote server and the client device;
determining whether the data relating to a user's progress through a video game is stored on the other of the remote server and the client device; and
in the event that it is determined not to be, transmitting the data relating to a user's progress through a video game to the other of the remote server and the client device.

Preferably, the method comprises:
determining the bandwidth of the connection between the client device and the remote server via the telecommunications network; and
varying the resolution of the moving object data streamed from the remote server to the client device in dependence on the determined bandwidth.

Preferably, the data relating to the output of video game content comprises user input control signals relating to the movement of one or more objects, and the method comprises:
streaming the moving object data from the remote server to the client device in dependence on the user input control signals.

Preferably, the moving object data is representative of two or more objects, and the method comprises:
synchronising the relative movement between the two or more objects on the remote server prior to streaming the moving object data from the remote server to the client device.

Preferably, the method comprises:
storing advertisement data representative of at least one advertisement on the remote server;
streaming the advertisement data to the client device together with the moving object data;
combining the moving object data and the advertisement data with the background data to produce video game content comprising an image in which the one or more objects move and at least one advert; and

outputting the video game content to the user

According to a second aspect of the present invention, there is provided a network for providing video game content to a user, comprising:
a client device comprising processing means, storage means adapted to store video game background data and display means; and
a remote server comprising storage means adapted to store moving object data representative of one or more moving objects;
wherein the client device and the remote server are connected to each other via a telecommunications network;
the processing means is operable to transmit a signal to the remote server, the signal comprising data relating to the output of video game content;
the remote server is operable to stream the moving object data to the client device in response to receiving the signal; and
the processing means is further operable to combine the moving object data and the background data to produce video game content comprising an image in which the one or more objects move and output the video game content to the user via the display means.

As such, in addition to making piracy difficult, the present network can be used to offload computationally intensive tasks from the client device onto to the server. This can allow more complex games to be played on the client device than otherwise would be the case. This is particularly applicable where the or each moving object is a representation of a three dimensional object. As such, the moving object data may comprise a two-dimensional representation of the or each moving object, and the remote server may be arranged to render the two-dimensional representation, typically from a three-dimensional model.

Where the video game background data comprises a representation of a background on which the or each moving object moves, the remote server may be arranged to render reflections from the background on the or each moving object. In such a case, the signal may comprise sufficient information for the remote server to reconstruct the background around the or each moving object.

In one embodiment, the storage means of the remote server may contain a representation of the background, which may be a copy of the video game background data. Furthermore, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

Equally, with three dimensional videogames, the remote server may still be arranged render the reflections on the surface of the moving object; the moving object data will comprise a three-dimensional representation of the moving object with reflections embedded therein.

In a further alternative, the remote server may be arranged so as to determine the content of a background; the signal would then comprise a list of items used to build up the background. The client device storage means may store, as part of the background data, images of a plurality of possible items from which the items in the list are selected. The signal would typically also include a position, typically three dimensional and so typically comprising lateral, two dimensional position and depth, for each of the items in the list. The client device processing means may be arranged to, as part of combining the moving object data and the background data, generate the background by overlaying the images corresponding to each of the items in the list in accordance with the position of each of the items. Typically, the depth would be used to decide which image would overlay each other image.

Preferably, the remote server is arranged to authenticate the user and only stream the moving object data in response to a successful authentication. In one embodiment, the storage means of the remote server is adapted to store first authentication data, the processing means is operable to transmit second authentication data together with the signal comprising data relating to the output of video game content, and the remote server is configured to compare the first and second authentication data and stream the moving object data from the remote server to the client device in dependence on a match between the first and second authentication data.

More preferably, said first and second authentication data comprise at least one of an IP address, a Media Access Control (MAC) address, a username and a user account password.

The remote server may be arranged to determine a successful authentication of the user for a period of time dependent upon the user having paid a fee.

The remote server may be arranged to determine whether the user is permitted to access a particular subset of the moving object data indicated by the signal. As such, the user may only be permitted to access certain parts of a particular game. Access to other subsets of the moving object data may be permitted once the user has completed a certain part of the game, or has paid a fee.

Preferably, the processing means is configured to store data relating to a user's progress through a video game on the storage means of the client device in response to a break in the connection between the remote server and the client device,
the remote server is configured to store data relating to a user's progress through a video game on the storage means of the remote server in response to a break in the connection between the remote server and the client device; and
when the connection is re-established, the processing means is operable to combine the moving object data and the background data to produce video game content in dependence on the data relating to a user's progress so as to resume the video game from the point at which the connection was broken.

Preferably, the processing means is configured to store data relating to a user's progress through a video game on the storage means of the client device and the remote server is configured to store data relating to a user's progress through a video game on the storage means of the remote server.

Preferably, the remote server is operable to determine the bandwidth of the connection between the client device and the remote server via the telecommunications network, and to vary the resolution of the moving object data streamed from the remote server to the client device in dependence on the determined bandwidth.

Preferably, the client device comprising user input means for inputting control signals relating to the movement of one or more objects; and wherein the remote server is configured to stream the moving object data to the client device in dependence on the user input control signals.

Preferably, the moving object data is representative of two or more objects, and the remote server is operable to synchronise the relative movement between the two or more objects prior to streaming the moving object data to the client device.

According to a third aspect of the present invention, there is provided a method of providing video game moving object data to a client device via a telecommunications network, the method comprising:
storing moving object data representative of one or more moving objects on a remote server;
streaming the moving object data to the client device in response to receiving a signal relating to the output of video game content.

The method may have any of the optional features recited in respect of the first aspect of the invention.

Additionally, the present method can be used to offload computationally intensive tasks from the client device onto to the server. This can allow more complex games to be played on the client device than otherwise would be the case. This is particularly applicable where the or each moving object is a representation of a three dimensional object. As such, the moving object data may comprise a two-dimensional representation of the or each moving object, and the method may comprise rendering on the remote server the two-dimensional representation, typically from a three-dimensional model.

The step of rendering the two-dimensional representation on the server may comprise rendering reflections from a background around the or each moving object on the or each moving object. In such a case, the signal may comprise sufficient information for the remote server to reconstruct the background around the or each moving object.

In one embodiment, the remote server may have a representation of the background. Furthermore, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

Equally, with three dimensional videogames, the remote server may still render the reflections on the surface of the moving object; the moving object data will comprise a three-dimensional representation of the moving object with reflections embedded therein. In a further alternative, the content of a background is determined at the remote server; the signal would then comprise a list of items used to build up the background. The signal would typically also include a position, typically three dimensional and so typically comprising lateral, two dimensional position and depth, for each of the items in the list.

Preferably, the method comprises authenticating the user on the remote server and streaming the moving object data only if the user is successfully authenticated. In one embodiment, this may comprise:
storing first authentication data on the remote server;
transmitting second authentication data together with the signal comprising data relating to the output of video game content;
comparing the first and second authentication data; and
streaming the moving object data from the remote server to the client device in dependence on determining a match between the first and second authentication data.

More preferably, said first and second authentication data comprise at least one of an IP address, a Media Access Control (MAC) address, a username and a user account password.

The step of authenticating the user may comprise determining a successful authentication of the user for a period of time dependent upon the user having paid a fee.

The step of authenticating the user may comprise determining whether the user is permitted to access a particular subset of the moving object data indicated by the signal. As such, the user may only be permitted to access certain parts of a particular game. Access to other subsets of the moving object data may be permitted once the user has completed a certain part of the game, or has paid a fee.

According to a fourth aspect of the present invention, there is provided a remote server comprising storage means adapted to store moving object data representative of one or more moving objects of a video game, the remote server being operable to stream the moving object data to a client device via a telecommunications network in response to a signal received from the client device, the signal comprising data relating to the output of video game content.

Preferably, the moving object data does not contain video game background data such that moving object data alone does not permit a user to play the video game.

The or each moving object may be a representation of a three dimensional object. As such, the moving object data may comprise a two-dimensional representation of the or each moving object, and the remote server may be arranged to render the two-dimensional representation, typically from a three-dimensional model.

The remote server may be arranged to render rendering reflections from a background surrounding the or each moving object on the or each moving object. In such a case, the signal may comprise sufficient information for the remote server to reconstruct the background around the or each moving object.

In one embodiment, the storage means of the remote server may contain a representation of the background. Furthermore, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

Equally, with three dimensional videogames, the remote server may still be arranged render the reflections on the surface of the moving object; the moving object data will comprise a three-dimensional representation of the moving object with reflections embedded therein.

In a further alternative, the remote server may be arranged so as to determine the content of a background; the signal would then comprise a list of items used to build up the background. The signal would typically also include a position, typically three dimensional and so typically comprising lateral, two dimensional position and depth, for each of the items in the list.

Preferably, the remote server is arranged to authenticate the user and only stream the moving object data in response to a successful authentication. In one embodiment, the storage means of the remote server is adapted to store first authentication data, the remote server being arranged to compare said first authentication data with second authentication data received from a client device and to stream the moving object data to the client device in dependence on determining a match between the first and second authentication data.

The remote server may be arranged to determine a successful authentication of the user for a period of time dependent upon the user having paid a fee.

The remote server may be arranged to determine whether the user is permitted to access a particular subset of the moving object data indicated by the signal. As such, the user may only be permitted to access certain parts of a particular game. Access to other subsets of the moving object data may be permitted once the user has completed a certain part of the game, or has paid a fee.

More preferably, said first authentication data comprise at least one of an IP address, a Media Access Control (MAC) address, a username and a user account password.

Preferably, the remote server is arranged to store data relating to a user's progress through a video game on the storage means in response to a break in the connection between the remote server and the client device and, when the connection is re-established, to stream the data relating to a user's progress through a video game and the moving object data to the client device.

Preferably, the remote server is arranged to determine the bandwidth of the connection with the client device, and vary the resolution of the moving object data streamed to the client device in dependence on the determined bandwidth.

Preferably, the remote server is arranged to reduce the resolution of the moving object data streamed to the client device in response to determining a reduction in the bandwidth of the connection.

Preferably, the data relating to the output of video game content comprises user input control signals relating to the movement of one or more objects, and the remote server is arranged to stream the moving object data to the client device in dependence on the user input control signals.

Preferably, the moving object data is representative of two or more objects, the remote server being arranged to synchronise the relative movement between the two or more objects prior to streaming the moving object data to the client device.

Preferably, the storage means being adapted to store advertisement data representative of at least one advertisement, and the remote server being arranged to streaming the advertisement data to the client device together with the moving object data.

Preferably, the storage means is adapted to store a portion of the background data associated with the video game, the remote server being operable to receive a request from a client device, the request relating to background data stored on the storage means, and to stream the requested background data to the client device together with the moving object data.

Preferably, the remote server is operable to generate background positioning information in response to the signal comprising data relating to the output of video game content, and to stream the background positioning information to the client device together with the moving object data.

The remote server may have any of the optional features recited with respect to the second aspect of the invention.

According to a fifth aspect of the present invention, there is provided a method of providing video game content to a user from a client device, the client device being connected to a remote server via a telecommunications network, the method comprising:
storing video game background data at the client device;
transmitting a signal from the client device, the signal comprising data relating to the output of video game content;
receiving moving object data representative of one or more moving objects streamed from the remote server;
combining the moving object data and the background data to produce video game content comprising an image in which the one or more objects move; and
outputting the video game content to the user.

The present method can therefore be used to offload computationally intensive tasks from the client device onto to the server. This can allow more complex games to be played on the client device than otherwise would be the case. This is particularly applicable where the or each moving object is a representation of a three dimensional object. As such, the moving object data may comprise a two-dimensional representation of the or each moving object.

So that the remote server can render the two-dimensional representation, where the video game background data comprises a representation of a background on which the or each moving object moves, the signal may comprise sufficient information for the remote server to reconstruct the background around the or each moving object.

For example, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

In a further alternative, where the remote server is arranged so as to determine the content of a background, the signal can comprise a list of items used to build up the background. The client device storage means may store, as part of the background data, images of a plurality of possible items from which the items in the list are selected. The signal would typically also include a position, typically three dimensional and so typically comprising lateral, two dimensional position and depth, for each of the items in the list. The client device processing means may be arranged to, as part of combining the moving object data and the background data, generate the background by overlaying the images corresponding to each of the items in the list in accordance with the position of each of the items. Typically, the depth would be used to decide which image would overlay each other image.

The method may comprise any of the optional features recited with respect to the first aspect of the invention.

According to a sixth aspect of the present invention, there is provided a client device comprising user input means, storage means adapted to store video game background data, a network interface and processing means, the processing means being arranged to transmit a signal to a remote server connected via a telecommunications network over the network interface, the signal comprising data relating to the output of video game content;
the network interface being arranged to receive moving object data streamed from the remote server in response to the signal; and
the processing means being arranged to combine the moving object data and the background data to produce video game content comprising an image in which the one or more objects move; and to output the video game content to the user.

As such, in addition to making piracy difficult, the present client device can offload computationally intensive tasks to the server. This can allow more complex games to be played on the client device than otherwise would be the case. This is particularly applicable where the or each moving object is a representation of a three dimensional object. As such, the moving object data may comprise a two-dimensional representation of the or each moving object.

So that the remote server can render the two-dimensional representation, where the video game background data comprises a representation of a background on which the or each moving object moves, the signal may comprise sufficient information for the remote server to reconstruct the background around the or each moving object.

In one example, the signal may comprise an indication of a position of the or each moving object relative to the background. This is useful where only a limited number of backgrounds are provided.

Alternatively, the signal may comprise a description of a plurality of objects surrounding the or each moving object. This is useful where the background is generated when the video game is played, particularly from a known list of objects (such as trees, hoardings, road surface or the like).

This will allow the correct reflections to be generated at the server, then transmitted to the client device as part of the moving object data. The appearance of the or each moving object therefore appears realistic, despite the fact that its appearance is remotely generated. Generation of the correct reflections is computationally intensive, and so it may also be advantageous to offload that task to a more powerful processor than is present on the client device.

In a further alternative, where the content of a background can be determined at the remote server, the signal could then comprise a list of items used to build up the background. The client device may store, as part of the background data, images of a plurality of possible items from which the items in the list are selected. The signal would typically also include a position, typically three dimensional and so typically comprising lateral, two dimensional position and depth, for each of the items in the list. The client device may, as part of the step of combining the moving object data and the background data, generate the background by overlaying the images corresponding to each of the items in the list in accordance with the position of each of the items. Typically, the depth would be used to decide which image would overlay each other image.

Preferably, the video game background data is representative of a background shown during the video game, but does not contain moving object data to enable the video game to be played.

Preferably, the storage means is adapted to store authentication data, the processing means being arranged to transmit the authentication data over the network interface to the remote server. More preferably, the authentication data comprise at least one of an IP address, a Media Access Control (MAC) address, a username and a user account password.

Preferably, the processing means being arranged to store data relating to a user's progress through a video game on the storage means in response to a break in connection between the client device and the remote server and, when the connection is re-established, to combine the moving object data and the background data in dependence on the data relating to a user's progress so as to resume the video game from the point at which the connection was broken.

Preferably, the processing means is adapted to receive control signals relating to the movement of one or more objects from the user input means and to transmit the data relating to the output of video game content comprising the received user input control signals over the network interface to the remote server

Preferably, the video game background data comprises only a portion of the total background data associated with the video game, the processing means being operable to determine whether background data required to be output is stored on the storage means and to transmit a request for background data to the remote server via the network interface in the event that the required background data is determined not to be stored on the storage means.

Preferably, the network interface is arranged to receive background positioning information together with the moving object data streamed from the remote server, and the processing means is operable to combine the background data and the moving object data in dependence on the background positioning information.

The client device may have any of the optional features recited with respect to the second aspect of the invention.

According to a seventh aspect of the present invention, there is provided a data carrier having computer readable code stored thereon, the code comprising video game background data representative of a background shown during the video game wherein, when the code is run on a suitable processing means, the background data can be combined with streamed moving object data representative of one or more moving objects to produce video game content comprising an image in which the one or more objects move relative to the background.

The data carrier may comprise one of an optical disk, a magnetic disk, a solid state memory and an electronic signal for transmission over a telecommunications network.

Typically, when run on a suitable client device, the code will cause the client device to operate in accordance with a method according to the first aspect of the invention.

According to a eighth aspect of the present invention, there is provided a method of placing in-game advertisements in video game content provided to the user of a client device, the client device being connected to a remote server via a telecommunications network, the method comprising:
storing video game background data at the client device;
storing moving object data representative of one or more moving objects and advertisement data on the remote server;
transmitting a signal from the client device, the signal comprising data relating to the output of video game content;
streaming the moving object data and the advertisement data from the remote server to the client device in response to receiving the signal;
combining the moving object data and the advertisement data with the background data to produce video game content comprising an image in which the one or more objects move and at least one advert; and
outputting the video game content to the user.

Preferably, the method comprises the step of storing a profile of the user on the remote server, and selecting the advertisement data dependent upon information contained within the profile. This is particularly advantageous when the method comprises authenticating the user on the remote server, typically by storing first authentication data on the remote server (typically in the profile); transmitting second authentication data together with the signal comprising data relating to the output of video game content; comparing the first and second authentication data; and streaming the moving object data from the remote server to the client device in dependence on determining a match between the first and second authentication data.

This is advantageous, as it allows for personalisation of the user; if the user is to be authenticated in any case to allow access to the moving object data, the profile that is stored for that purpose can be used to personalise the advertisements sent to the user.

The method may comprise capturing the user's speech. The method may comprise recognising words or phrases in the user's speech, and selecting the advertisement data dependent upon the words or phrases recognised.

Furthermore, the method may comprise determining the direction of the user's gaze, determining whether the user is looking at the or each advert and recording on the remote server, typically as part of the profile, which adverts the user has looked at. This provides useful feedback to third parties providing such adverts. The method can also comprise determining the length of time for which a user looks at the or each advert and recording the length of time on the remote server, typically as part of the profile.

The profile may contain a list of contacts of the user, perhaps on at least one social networking site. The method may comprise sending advertisements selected dependent upon the information in the user's profile to the user's contacts. The user's contacts may also have profiles stored on the storage means of the remote server; the adverts streamed to the user may depend on the content of the user's contacts' profiles.

Preferred and/or optional features of the first aspect of the invention may be incorporated within the system of the second aspect, the method of the third aspect, the remote server of the fourth aspect, the method of the fifth aspect, the client device of the sixth aspect, the data carrier of the seventh aspect or the method of the eighth aspect, alone or in appropriate combination.

Embodiments of the present invention will now be described, by way of example only, with reference to the accompanying drawings, in which:

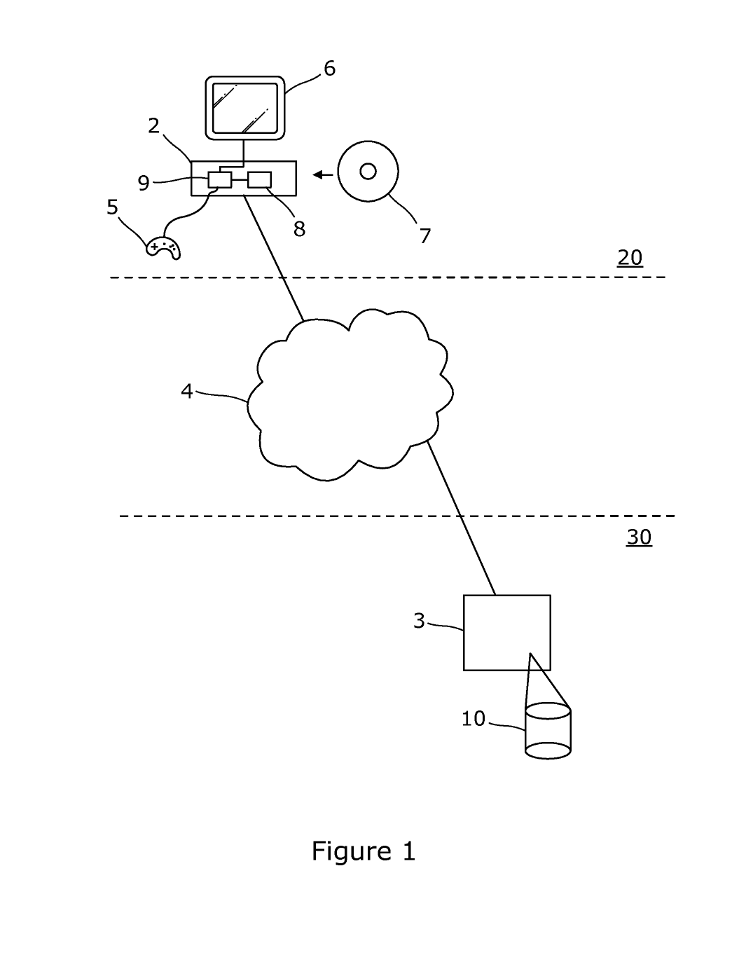

FIG. 1 shows a system for providing video game content to a user according to an embodiment of the present invention;

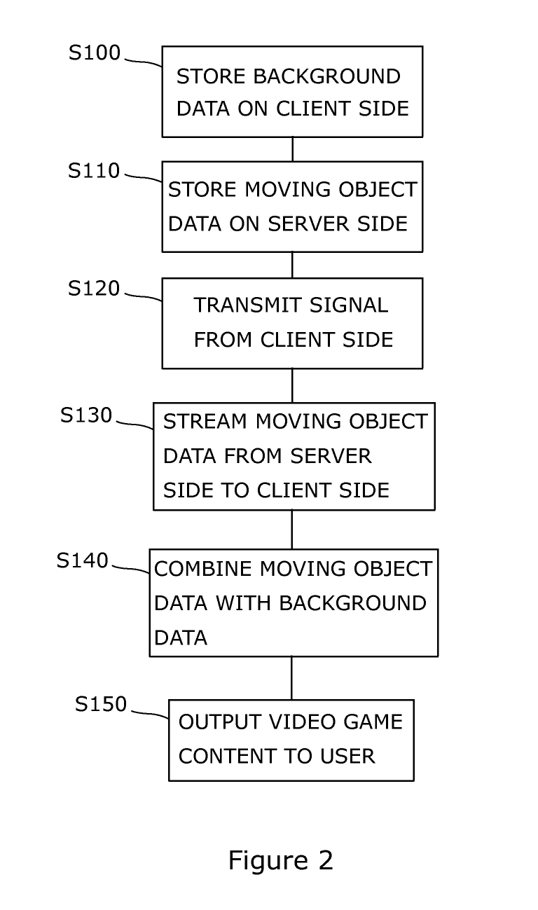

FIG. 2 is a flowchart showing a method of providing video game content to a user according to an embodiment of the present invention;

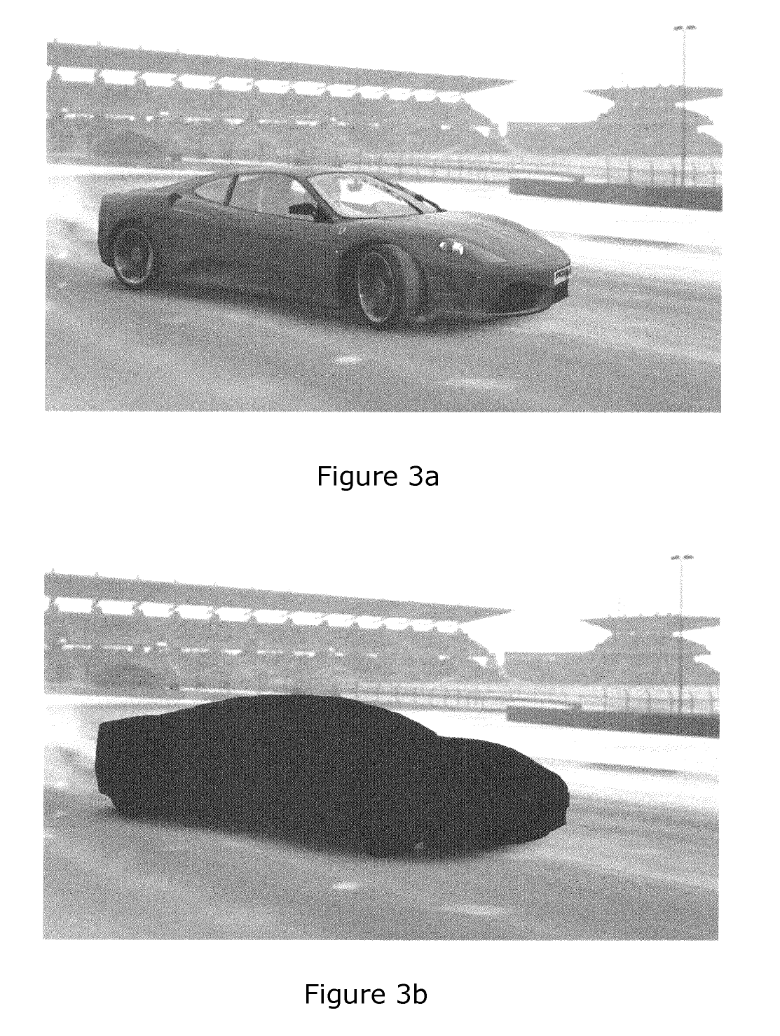

FIG. 3a shows a first example of video game content comprising background data and moving object data;

FIG. 3b shows the video game content of FIG. 3a comprising only the background data, the moving object data of FIG. 3a being shown in outline for illustrative purposes only;

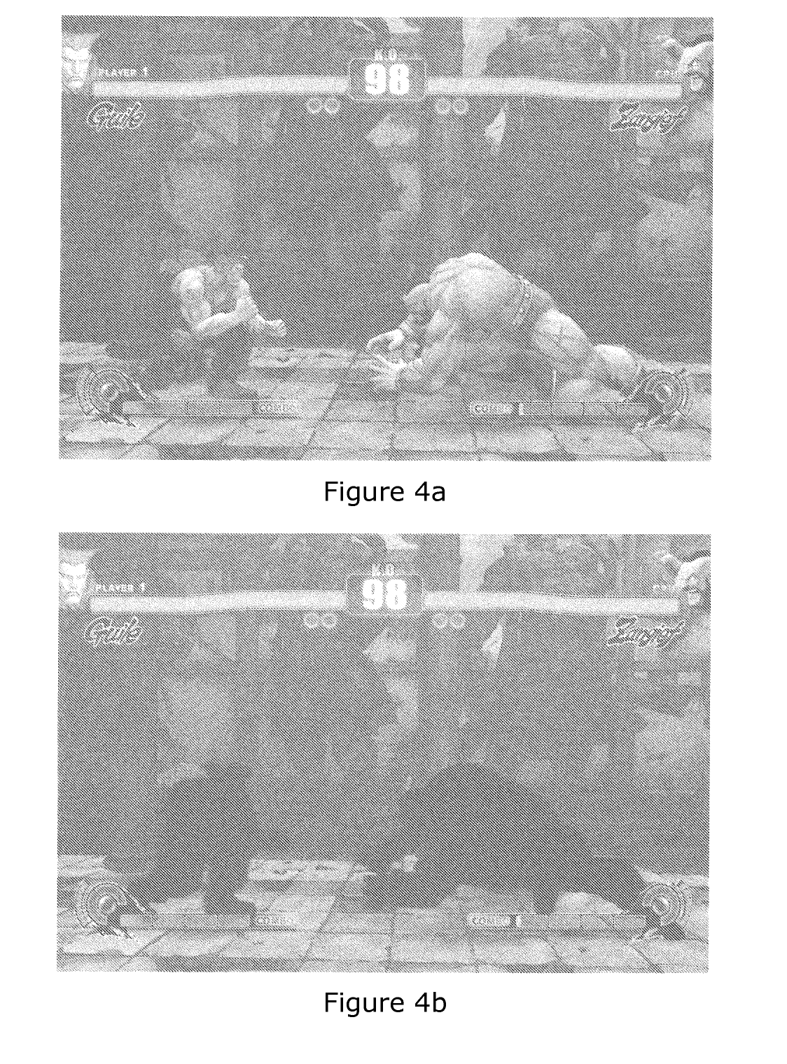

FIG. 4a shows a second example of video game content comprising background data and moving object data;

FIG. 4b shows the video game content of FIG. 4a comprising only the background data, the moving object data of FIG. 4a being shown in outline for illustrative purposes only;

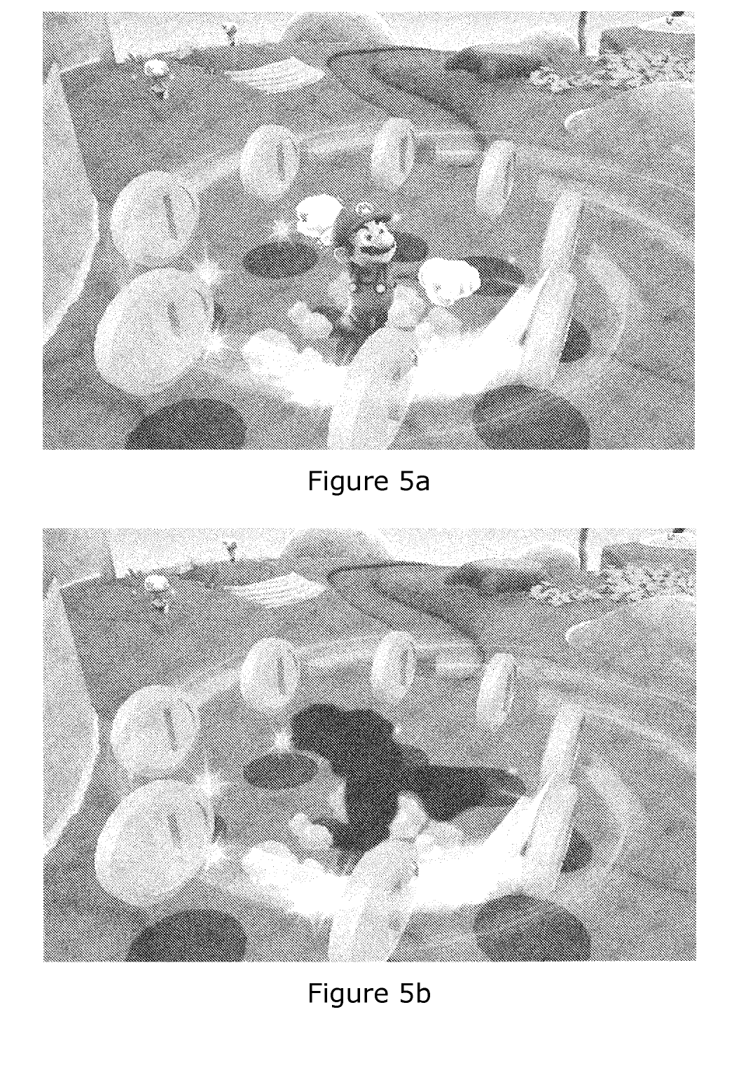

FIG. 5a shows a third example of video game content comprising background data and moving object data;

FIG. 5b shows the video game content of FIG. 5a comprising only the background data, the moving object data of FIG. 5a being shown in outline for illustrative purposes only;

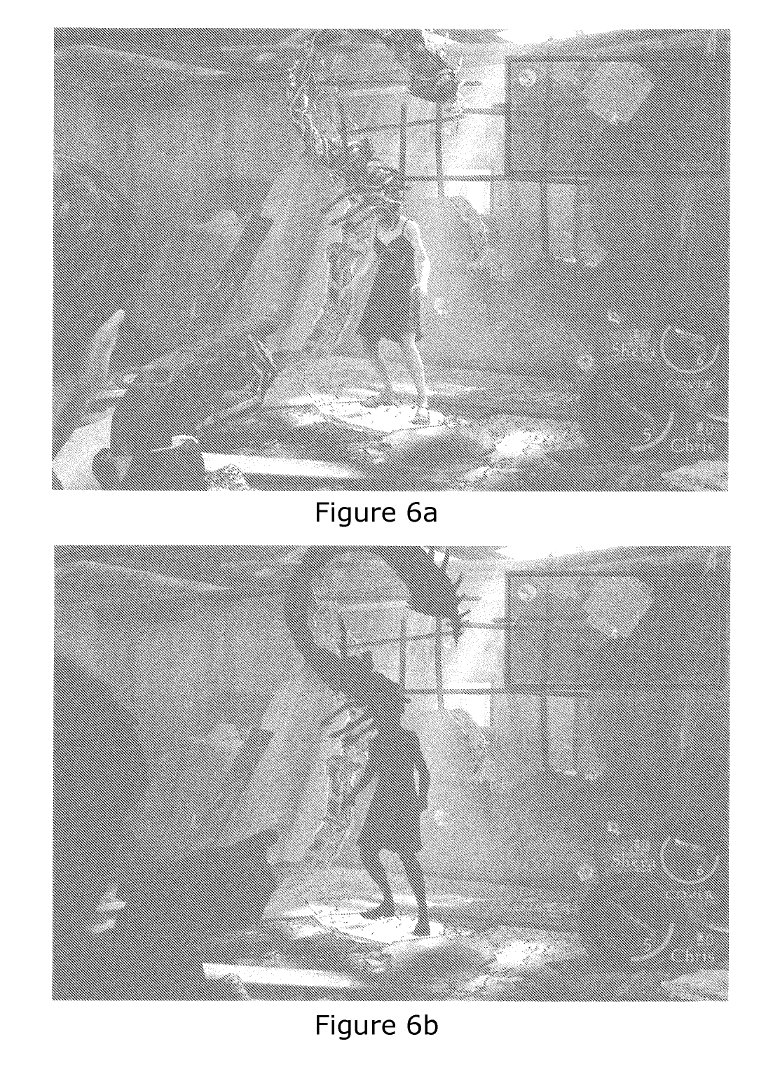

FIG. 6a shows a fourth example of video game content comprising background data and moving object data;

FIG. 6b shows the video game content of FIG. 6a comprising only the background data, the moving object data of FIG. 6a being shown in outline for illustrative purposes only;

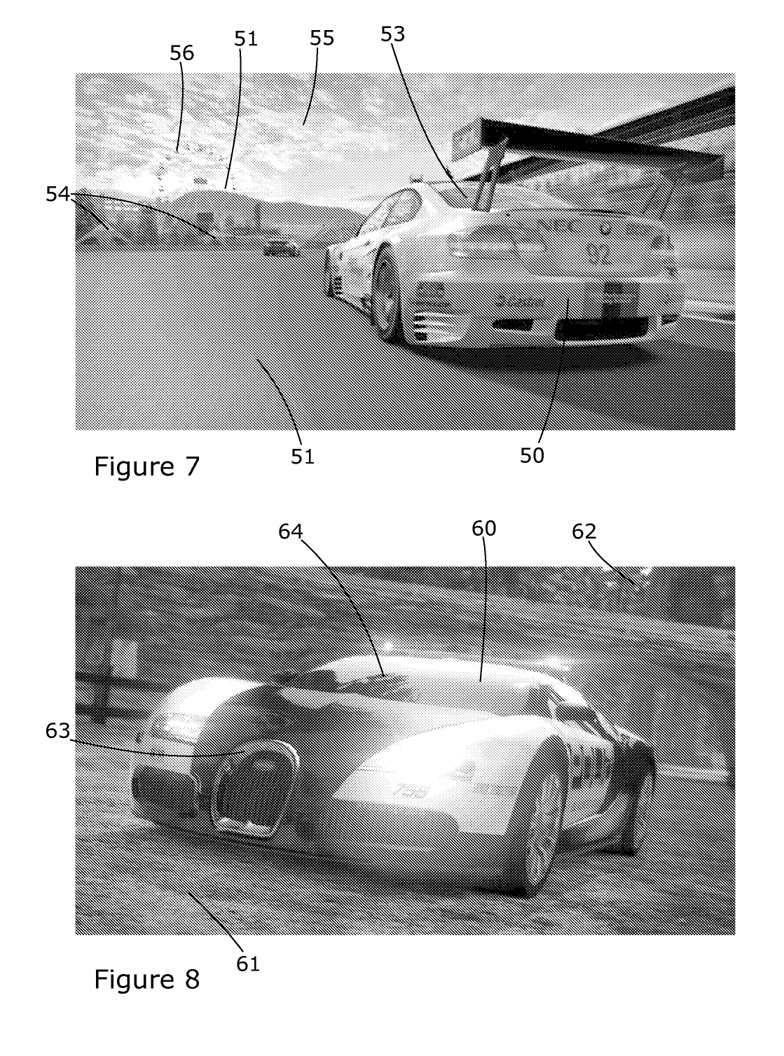

FIG. 7 shows a fifth example of video game content comprising background data and moving object data;

FIG. 8 shows a sixth example of video game content comprising background data and moving object data;

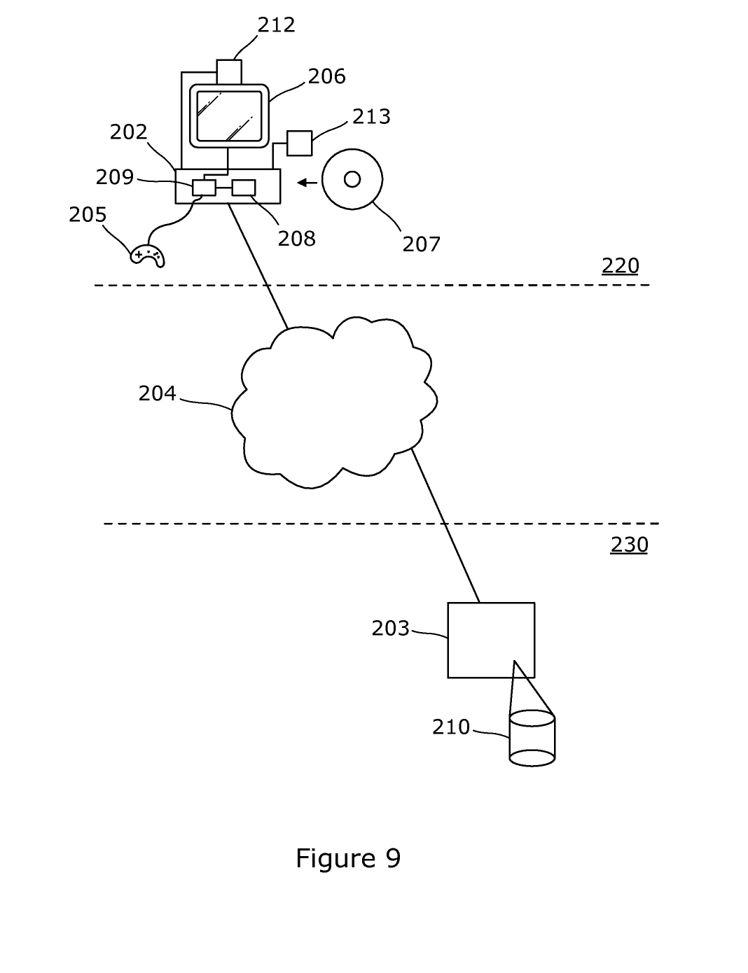

FIG. 9 shows a system for providing video game content to a user according to a further embodiment of the present invention; and

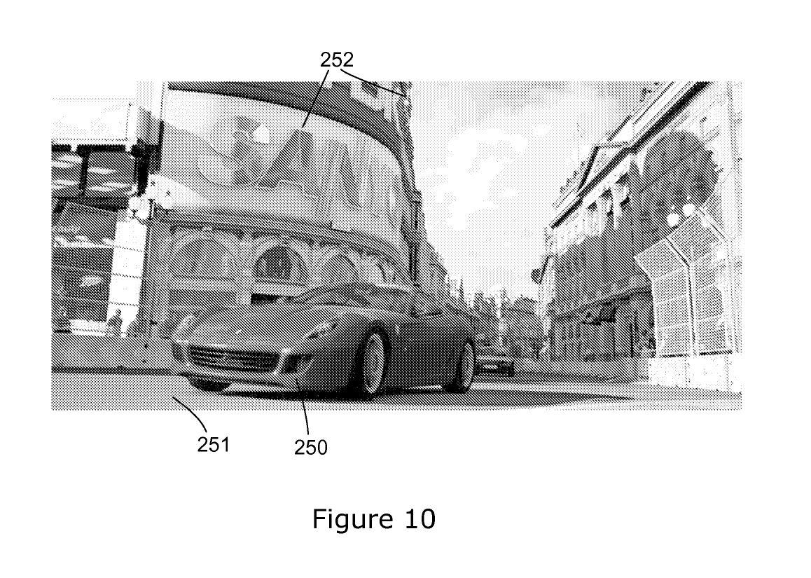

FIG. 10 shows a seventh example of video game content comprising background data and moving object data.

Referring to FIG. 1, the system 1 comprises a client device 2, a remote server 3 and a telecommunications network 4. The client device 2 and the remote server 3 are each connected to the telecommunications network 4 so as to enable the transfer of data therebetween. The client device 2 is disposed on a client side 20 of the telecommunications network 4 and the remote server 3 is disposed on a server side 30 of the telecommunications network 4.

In the present embodiment, the client device 2 is a games console and is provided with user input means 5 in the form of a control pad. The client device 2 is also connected to display means 6 (such as a television or computer monitor) for outputting video game content to a user.

Video game background data for a particular video game is provided on an optical disk 7, such as a CD-ROM, which the user must purchase from an authorised distributor in order to play the video game. The background data is representative of a background shown when the video game is being played. The client device 2 is provided with means (not shown) for reading the background data from the optical disk 7, and a memory 8 for storing the background data read from the optical disk 7. Depending on the size of the memory 8 of the client device 2, all of the background data may be read from the optical disk 7 prior to a user playing the video game. Alternatively, portions of the background data may be read from the optical disk 7 during gameplay as required. The client device 2 also has processing means 9 which controls the operation of the client device 2 as will be explained in more detail later.

The remote server 3 is provided with storage means 10 for storing moving object data associated with the particular video game to be played by a user. The remote server 3 may store moving object data associated with plurality of video games. The moving object data is representative of one or more objects which move relative to the background during gameplay.

Referring to FIG. 2, a method for providing video game content to a user will now be described.

In Step 100, video game background data for a particular video game to be played by a user is stored on the client side 20. As mentioned previously, the background data is provided on the optical disk 7, and may be transferred, in all or in part, to the memory 8 of the client device 2 as required during gameplay.

The nature of the background data depends on the type of video game being played. In the present embodiment, the video game is a car racing game. Such a game typically comprises a number of circuits or stages around which a car controlled by the user races against other cars or against the clock. Accordingly, referring to FIGS. 3a and 3b, the background data comprises the data relating to the stages or circuits, but not the car itself.

In Step 110, moving object data associated with the particular video game to be played is stored on the server side 30. As mentioned previously, the storage means 10 of the remote server 3 may store moving object data for a plurality of video games. In the present embodiment, the moving object data is representative of a car which is controlled by the user via the input means 5 of the client device 2. In particular, the moving object data comprises graphics data which determine the appearance of the user controlled car on the display means 6 when video game content is output and source code which determines how the car responds to a user's commands input using the input means 5.

In Step 120, when a user commences gameplay, for example by inputting a command via the user input means 5, the processing means 9 of the client device 2 is operable to send a signal to the remote server 3 via the telecommunications network 4. The signal sent from the client device 2 comprises data relating to the output of video game content. For example, a user playing the car racing game may input a command for the car to accelerate, decelerate, steer left, steer right, etc.

In Step 130, when the signal from the client device 2 is received at the remote server 3, the remote server 3 is operable to identify the moving object data stored in the storage means 10 which is appropriate to the video game being played by the user and the command input by the user via the input means 5. Thereafter, the moving object data is streamed from the remote server 3 to the client device 2 via the telecommunications network 4.

In Step 140, the processing means 9 of the client device 2 is operable to combine the moving object data streamed from the remote server 3 with the background data stored in the memory 8 to produce video game content to be output. The background data and the moving object data are combined so as to produce an game image in which one or more objects associated with the moving object data move. As shown in FIG. 3a, the image of the car is superimposed on the image of the circuit in the background so as to produce an image in which the car appear to move around the circuit. The moving object data is synchronised with the background data in real time such that the background always matches the movements of the object, i.e. the car, as it is controlled by the user. FIG. 3b illustrates the distinction between the moving object data and the background by showing the moving object, i.e. the car, in outline. It should be noted that, without the moving object data, the video game content output to the user would comprise just a background image showing no indication of the size, shape or position of the moving object, thus rendering the video game unplayable.

In Step 150, the video game content comprising the combined background data and moving object data is output to the user via the display means 6.

As the user plays the game and inputs further commands via the input means 5, corresponding moving object data is streamed from the remote server 3 and synchronised with the background data by the processing means 9 of the client device 2 before being output to the display means 6. For example, if a user inputs a command for the car to turn left, the command is transmitted in a signal to the remote server 3, and the remote server 3 is operable to stream an image of the car turning left to the client device 2. The streamed image of the car is synchronised with background data such that when the two are combined the car appears to be moving left relative to the background. Depending on the particular video game, the movement of the object which is streamed from the remote server 3 may be relative to the background, relative to the actual position of the object as it appears on the display means 6, or a combination of the two.

By virtue of the above-described method, video game piracy may be prevented because only part of the video game data required to play the game is stored on the client side 20. For the game to function correctly, the moving object data must be streamed from the server side 30 via the telecommunications network 4. The streamed data is not stored on the client side 20, therefore, even if an unauthorised copy of the background data stored on the client side 20 is made, such a copy is incomplete and therefore of no use to a consumer.

Furthermore, the moving object data stored on the server side 30 represents only a small portion of the video game content compared to the background data stored on the client side 20. Accordingly, with the above-described method, only a relatively narrow bandwidth connection is required to stream the moving object data over the telecommunications network 4 compared to the bandwidth which would be required to stream the entire video game, comprising background data and moving object data, from the remote server 3 to the client device 2. Moreover, since the moving object data represents only a relatively small portion of the content of an entire video game, the amount of storage capacity of the remote server 3 can be kept to a minimum, thereby reducing costs.

The signal transmitted to the remote server 3 from the client device 2 in Step 120 may be used to authenticate the client device 2 and/or the user prior to the streaming of the moving object data in Step 130. For example, the remote server 3 may store authentication data relating to a particular client device and/or a particular user in the storage means 10. The authentication data may include one or more of the Internet Protocol (IP) address of the client device, a username and/or password associated with a particular user's account, and the Media Access Control (MAC) address of the client device 2. In this way, it is possible to ensure that the moving object data for a particular game is only streamed to registered users. Furthermore, a check can be made to ensure that not more than one user is assigned to the same IP, MAC address account.

The above-described system 1 may be provided with an ‘auto-resume’ function in the event that the connection between the remote server 3 and the client device 2 is broken during gameplay. Accordingly, when the connection to the telecommunications network 4 is lost, both the remote server 3 and the client 2 are operable to determine the point in the game at which the connection was lost, and store this information in the storage means 10 and the memory 8, respectively. When the connection is re-established the remote server 3 is operable to stream the moving object data from the point at which the connection was lost and the processing means 9 of the client device is operable to synchronise the streamed moving object data with the background data accordingly.

Furthermore, data associated with a user's progress through the game, such as the levels completed, high score data, etc. can be stored both in the memory 8 of the client device 2 and can also be sent to the remote server 3 to be stored on the storage means 10.

Accordingly, in the event that something happens to client device 2, such as damage to the memory 8 or theft of the client device 2, the data associated with the user's progress through the game can be sent from the remote server 3 the next time a user plays the game after the client device 2 has been repaired or replaced. Similarly, in the event that anything happens to the data relating to a user's progress through the game which is stored in the storage means 10 of the remote server 3, the copy of the data stored in the memory 8 of the client device 2 acts as a back-up and can be transmitted to the remote server 3 the next time a connection is established.

The processing means 9 of the client device 2 may be operable to determine the delay between the transmission of the signal in Step 120 and receiving the streamed moving object data in Step 130. Accordingly, the processing means 9 may dynamically determine the bandwidth of the connection to the remote server 3 via the telecommunications network 4 during gameplay. The remote server 3 may be operable to vary the resolution of the moving object data streamed in Step 130 in dependence on the determined bandwidth. For example, in the case that there is a high level of traffic on the telecommunications network 4 which results in a lower bandwidth connection between the client device 2 and the remote server 3, the remote server 3 may stream the moving object data at a lower resolution, such that the speed of the game play is not adversely affected.

The moving object data may relate to a number of objects which move relative to one another and relative to the background. For example, in the car racing game, the moving object data may relate to a car controlled by the user and a number of additional cars controlled by the processing means 9 of the client device 2 or by additional users via additional user input means 5. Where the moving object data relates to more than one object, the relative movement between the objects can be synchronised by the remote server 3 prior to being streamed to the client device 2. Accordingly, should there be any discrepancy in the synchronisation of the moving object data and the background data, the interaction between the moving objects themselves is not affected.

In the above-described embodiment of the present invention the video game is a car racing game. However, it will be readily appreciated by the skilled person that the system and method of the present invention can be used for any type of video game. For example, referring to FIGS. 4a and 4b, the game may be a fighting game in which the moving objects are characters who can be controlled by a user and/or the processing means 9 of the client device 2 to fight each other. Referring to FIGS. 5a and 5b, the video game may be a so-called ‘platform’ game in which the moving object is a character controlled by the user to move around a series of levels. Referring to FIGS. 6a and 6b, the video game may be a first person ‘shoot-em up’ in which the moving objects are both a character controlled by the user and one or more enemy characters controlled by the processing means 9. In each case, the moving object data to be streamed from the remote server 3 represents a relatively small portion of the program code, which is essential for the video game to be played.

In the above-described embodiment of the present invention, the background data of the video game is provided on a CD-ROM from which it is loaded onto the client device 2. It will be appreciated by those skilled in the art that the background data of the video game may be provided on any other suitable storage medium, such as another type of optical disk, a magnetic disk, or a solid state memory device, such as a flash memory device or EEPROM. The storage medium on which the background data is stored, i.e. the disk or the like, may be given away for free by distributors since the game will not function without connection to the remote server 3. The free distribution of disks may increase the likelihood of a user paying to create an account allowing them to log on to the remote server 3 so that they can play the game, which is advantageous for game developers.

Furthermore, in an alternative embodiment of the present invention the background data of the video game may be downloaded via the telecommunications network 4 and stored directly on the memory 8 of the client device 2, such that the user is not required to purchase a physical copy of the video game from a retail outlet. Accordingly, this is advantageous for game developers since they retain a portion of the profits from selling the video game that would otherwise have gone to a retail outlet.

Moreover, in the above-described embodiment of the present invention, the client device 2 is a games console, such as a Playstation 3®, Xbox 360® or Nintendo Wii®. . However, as will be appreciated by the person skilled in the art, the client device 2 may be any device which can be used to play video games including home computers, such as a PC or an Apple Mac®, or a handheld gaming device which is capable of connecting to a telecommunications network. Furthermore, the client device may be a mobile telecommunications device, such as a mobile phone, or any other device that has a central processing unit (CPU), a graphics processing unit (GPU), a memory and a wired or wireless telecommunication connection such as televisions, set-top boxes, cable boxes, satellite boxes, digital music players, netbooks, notebooks, electronic gaming machines, etc.

Furthermore, in the above-described embodiment of the present invention, the user input means 5 is a control pad. However, the skilled person will appreciate that any suitable user input means can be used. For example, the user input means 5 may detect the movements of the user as control inputs (such as Microsoft's Kinect®) such that no control pad is required. Alternatively, a control pad including motion sensors may be used, such as the control pad for the Nintendo Wii®.

A further advantage of the above-described system and method of the present invention arises from the fact that the client device 2 must be connected to the telecommunications network 4 at all times during gameplay. The requirement for this constant connection provides the opportunity for additional video game content to be streamed together with the moving object data when a video game is being played. For example, in the car racing game of the above-described embodiment, a third party may wish to pay for an advertising banner or the like to be displayed on the car being controlled by the user, or another moving object. Previously, such in-game adverts would have to be included in the video game prior to its distribution to a consumer, and the cost of such advertising would reflect the fact that the advert would be a permanent feature of the game. The present invention allows for such adverts to be streamed together with the moving object data on an ad-hoc basis, thereby allowing advertisers the flexibility to place their adverts in the game for specified periods of time and to pay accordingly. This may be particularly useful for the advertising of seasonal products or products associated with a particular event during the year.

Given that the user has to authenticate themselves before the remote server 3 will stream the moving object data, the remote server 3 will typically need to store some details concerning the user. As such, the information, forming a profile of the user, can be used to select the advertisements that are presented to the user.

In an alternative embodiment, depicted in FIG. 9 of the accompanying drawings (equivalent integers being given the same reference numerals as for the embodiment of FIG. 1, raised by 200), the client device of FIG. 1 has been supplemented by the use of a microphone 213 and a motion tracking camera 214 mounted on the display means 216. The microphone captures the user's speech, and either determines the words or phrases spoken by the user, or transmits the user's speech to the remote server, which then carries out that determination. Speech recognition is a well known, mature technology, and suitable speech recognition packages such as those used by Nuance Communications® in their Dragon Dictation® software.

The words or phrases spoken by the user can be used to select the advertisements that are provided to the user; the words or phrases most frequently spoken can be stored in the user's profile. For example, if a user mentioned “trainers”, then an advert for a certain brand of footwear could be provided to the user. Third parties could bid for certain words; for example, the right to have advertisements when the word “trainer” is spoken could be sold to the highest bidder.

The advertisements could be static images rendered onto the background (for example, onto billboards), moving video similarly rendered, audio advertisements (in the example of a car racing game, potentially over a simulated radio playing in the car) or text displayed onscreen.

The user may be able to select the weather shown in the video game; this information could be recorded in the profile. This information could also be used to select advertisements; for example a user that selects a particularly sunny or snowy climate could be sent advertisements for sunshine or skiing holidays respectively.

In the image shown in FIG. 10 of the accompanying drawings, which represents the view that is presented to a user of the client device 202, a car 250, being the moving object, is shown travelling around a track 251. Advertisements 252 are visible on buildings surrounding the track 251. As shown in FIG. 10, the advertisements show “SANYO”® and “TDK”®, both electronics companies.

Depending on the information in the user's profile, and the words that the user speaks, different advertisements could be placed at 252 in FIG. 10; in the example that user has mentioned (either whilst playing this video game, or historically as recorded in the profile) “trainers”, an advert for footwear could be placed in place perhaps of the “SANYO” advertisement. In addition to being on the buildings, variable advertisements could be placed as decals on the car 250, at the tops of buildings, on billboards or anywhere else that is convenient. The advertisements can appear either on the moving object or on the background.

The profile can also contain a list of contacts of the user. Given that the user's contacts are likely to be friends of similar interests, the advertisements can be selected based upon the user's contacts profile information as well as the user's own profile information.

The motion tracking camera 214 can be used to track the user's gaze and determine where the user is looking on the display means 216, typically by tracking the reflection of the user's cornea relative to the centre of the user's pupil. Thus, the client device 2 can determine whether and for how long a user looks at the advertisements. This information can be uploaded to the user's profile, and used to target further advertisements to the user. Additionally, it can be used to charge the advertiser more for advertisements that are viewed more by the user than ones that are not.

Furthermore, if a stereo video camera is used, the distance of the user from the display means 216 can be determined; the size of the images on the display means 216 can be magnified or reduced in accordance with the user's distance. This allows images to be zoomed for far-away users, or reduced in size for nearby users.

In order to determine whether the user is authenticated, the storage means 210 of the remote server 203 will contain an indication of whether the user has paid for access to the moving object data. In particular, the video game may have the functionality that the user can pay for access for different parts (levels, objects, characters, stages, vehicles or so on) of the video game; as such, the storage means may indicate whether the user has paid for access to particular subsets of the moving object data.

Payment can be on several bases:
Pay per play
Monthly fee
Pay per hour
Single payment allowing access not limited by time

Payment may be possible through the client device, a mobile device or any convenient payment method. The payment per level, stage, item or so on may ramp up significantly as the user progresses through the game, with initial payments for the first level etc. being, say $10 then $25, $50, $150, $250, $1000, $10,000 or even higher. The user's previous payment may be available as a credit against further purchases. The areas for which the user has paid can be entered into the user's profile so that that information can be used to select advertisements to be provided to the user.

The access to only subsets of the moving object data need not be dependent upon payment; instead, different levels, objects, characters, stages, vehicles or so on could be unlocked at a user's mere request; this is particularly useful with games played by children, where the child's parents can allow or restrict access to parts of a video game based upon the child's good or bad behaviour, or if they think that part of a game may be unsuitable for their child.

The above-described system and method of the present invention may also be used for providing next generation movies to a user. Such movies may be interactive, such that the user can input commands via a user input means in order to determine how the movie progresses. Accordingly, interactive elements of the movie may be stored on the remote server 3 and streamed to the client device 2 of the end user as required.

Furthermore, aspects of the present invention may be used to prevent piracy of computer software other than video games. For example, the computer software may be a word processing application, wherein the source code for certain functionalities is stored on the remote server 3, and is streamed to the client device 2 when a user selects the function. Thus, the user does not have the full program code stored on the client side 20, in order to prevent copying. Alternatively, the computer software may be a photo editing application, where the source code for performing various editing functions is stored on the remote server 3 and streamed to the client device 2 as required.

A further embodiment of the present invention may be employed in the case that the client device 2 is not equipped with sufficient hardware to be able to process the video game locally on the client side 20, e.g. a mobile phone. In this case, the video game background data is stored in the memory 8 of the client device 2, but is processed on the server side 30 by the remote server 3, as the client device 2 does not have sufficient computing power to handle the processing of the background images. The remote server 3 is operable to process the movements of the background images as the game is played and to transmit positioning information relating to the background images, which is streamed together with the moving object data, to the client device 2. The client device 2 is operable to receive the positioning information and to use it to determine the appropriate background image to be output for display. As with the previously described embodiments, the streamed moving object data is combined with the background image data so as to produce the complete video game content. Since the background data is still stored on the client device 2, the additional bandwidth required for the transmission of the positioning information, on top of that required for streaming the moving object data, is small. Thus, it is possible for a user to play a video-game which requires more processing power than is available on the client device 2 on which the game is played.

It may also be the case that the client device 2 is unable to store or process all of the background data for a particular video game, e.g. due to insufficient RAM, memory, hardware, etc. In this situation only some of the background data can be stored in the memory 8 of the client device 2, with the remainder being stored on the remote server 3 together with the relevant moving object data for a particular video game. Accordingly, when the game is played on the client device 2 and the background data is stored on the client device 2, moving object data is streamed from the remote server 3 and combined with the background data stored on the client device 2 to produce the video game content to be output to the user. However, in the event that the required background data is not stored on the client device 2 and is instead stored on the remote server 3, the client device 2 is operable to request the required background data from the remote server 3. Upon receiving a request transmitted from the client device 2, the remote server 3 is operable to stream both the background data and the moving object data are to the client device 2. Accordingly, only a relatively small bandwidth connection is required when the background data is stored on the client device 2, a larger bandwidth only being required in the event that a portion of the video game background data cannot be stored on the client device 2 and is instead stored on the remote server 3. Optionally, the remote server 3 may also stream positioning information relating to the background data stored on the client device 2 as described previously, so that the processing of the background data does not have to be carried out on the client device 2.

In a further embodiment of the present invention, the remote server 3 is operable to compress data (i.e. moving object data, background positioning information and/or background data) before it is streamed to the client device 2. Similarly, the client device 2 is operable to decompress the streamed data before outputting the video game content to the user. Accordingly, the bandwidth required to play a video game is further reduced. It should also be noted that when the client device 2 is a device having a relatively small display size, e.g. mobiles phones or tablet devices having screens from around 2 to 9 inches in size, considerably less bandwidth is required to stream moving object data and/or other data from the remote server 3 to the client device 2 as compared to the bandwidth required for streaming data to a high definition television or the like.

A further embodiment of the invention can be demonstrated with reference to FIG. 7 of the accompanying drawings. In this embodiment, the game is a racing game, in which a car 50 races around a track 51. As in the FIG. 3a/3b embodiment, the car represents the moving object data, with the track 51 and surrounding area 52 forming the background data. As with the previous embodiments, the moving object data comprising the representation of the moving object—the car 50—is streamed from the remote server 3, the game being unplayable without the moving object data.

From FIG. 7, which shows the combined moving object and background data, it can be seen that there are reflections 53 visible on the surface of the car 50. These reflections are generated on the remote server 3. This is useful where the client device 2 is a handheld device and so likely to have a relatively low-powered processing means 9.

In order to do so, the signal transmitted in step 120 can contain information that allows the remote server to place the car 50 relative to the background (the track 51 and surrounding area 52). Where the background is one of a finite number of pre-determined courses, the signal can contain simply the coordinates of the car 50 relative to the background 51, 52.

Where the background is generated on the fly by the client device 2, the signal can include details of the background around the car. As such, the signal transmitted from the client device 2 to the remote server 3 will describe the background, by listing the elements making it up. For example, in the case shown in FIG. 7, the signal could contain the shape and type of the track 51 surface, a list of the items around the track 51, such as the fairground wheel 56 and tents 54 and their locations. Typically, the items around the track 51 will be selected from a predetermined list; the remote server 3 will therefore be provided with data describing the shape and appearance of, in this embodiment, the fairground wheel 53 and the tents 54. The signal will also indicate the position of the car 50 relative to the track 51 and a description of the sky 55.

From the information in the signal and data stored on the remote server 3 storage means 10, the remote server 3 will be able to generate a three dimensional model of the background 51, 52 and the car 50. From this, the remote server 3 will be able to render a two-dimensional representation of the car, which forms the moving object data which is streamed back to the client device 2. The data stored on the remote server 3 storage means 10 will comprise, in the case of predetermined courses, a three dimensional model of each of the courses and, in the case of on-the-fly generation, will comprise a three dimensional model of each of the possible items and the track surfaces, which are used to generate a three-dimensional model to match that generated on-the-fly by the client device 2.

Thus, the remote server 3 has the task of computing the reflections visible on the surface of the car 50. Example reflections can be seen at 53, where reflections of the clouds visible in the sky 55 can be seen. The rendering of reflections on a three-dimensional object into a moving two-dimensional representation is computationally intensive, and this method allows the computationally intensive task to be outsourced to the remote server 3.

The signal may also comprise an indication of changes, such as damage to the car; thus, the remote server 3 can model the effects of crashes, dents, lighting effects, shadows, shattered glass or the like on the car.

In an alternative version of this embodiment, the content of the background displayed at the client device 2 can be generated on the fly at the remote server 3. In such a case, the signal sent by the remote server 3 to the client device would contain a list of items making up the background (road surface, trees, hoardings and the like) and a three-dimensional coordinate for each. The client device would hold an image file corresponding to each of the possible items, and would create the background by appropriately overlaying the images on top of another based upon the lateral position and depth. The moving image data would then be overlaid on top. The filenames (or other references to the images of the items) would need to be consistent between the remote server 3 and the client device 2.

A further example of the reflections which it is possible to render using the present embodiment of the invention is shown with respect to FIG. 8, where both the track 61 and the surrounding trees 62 are reflected at 63, 64 respectively. The effects of these reflections and the necessary rendering of the car are carried out in the remote server 3.

Whilst the remote server has been shown as a single node, there is nothing in the present invention that requires the functions to be provided on a single node (although they could be); the functions of the remote server 3, 203 can be provided on multiple distributed network nodes.

1-46. (canceled)

47. A method of providing video game content to a user of a client device, the client device being connected to a remote server via a telecommunications network, the method comprising:
storing video game background data at the client device;
storing moving object data representative of one or more moving objects on the remote server;
transmitting a signal from the client side, the signal comprising data relating to the output of video game content;
streaming the moving object data but not the video game background data from the remote server to the client device in response to receiving the signal;
combining the moving object data and the background data to produce video game content comprising an image in which the one or more objects move; and
outputting the video game content to the user.

48. The method of claim 47, in which the or each moving object is a representation of a three dimensional object, the moving object data comprising a two-dimensional representation of the or each moving object, the method comprising rendering on the remote server the two-dimensional representation from a three-dimensional model.

49. The method of claim 48, in which the video game background data comprises a representation of a background on which the or each moving object moves, the step of rendering the two-dimensional representation on the server comprising rendering reflections from the background on the or each moving object, the signal comprising sufficient information for the remote server to reconstruct the background around the or each moving object.

50. The method of claim 49, in which the signal comprises an indication of a position of the or each moving object relative to the background.

51. The method of claim 49, in which the signal comprises a description of a plurality of objects surrounding the or each moving object.

52. The method of claim 47, comprising:
determining the bandwidth of the connection between the client device and the remote server via the telecommunications network; and
varying the resolution of the moving object data streamed from the remote server to the client device in dependence on the determined bandwidth.

53. The method according to claim 47, wherein the moving object data is representative of two or more objects, the method comprising:
synchronising the relative movement between the two or more objects on the remote server prior to streaming the moving object data from the remote server to the client device.

54. The method according to claim 47, comprising:
storing advertisement data representative of at least one advertisement on the remote server;
streaming the advertisement data to the client device together with the moving object data;
combining the moving object data and the advertisement data with the background data to produce video game content comprising an image in which the one or more objects move and at least one advert; and
outputting the video game content to the user.

55. A network for providing video game content to a user, comprising:
a client device comprising processing means, storage means adapted to store video game background data and display means; and
a remote server comprising storage means adapted to store moving object data representative of one or more moving objects;
wherein the client device and the remote server are connected to each other via a telecommunications network;
the processing means is operable to transmit a signal to the remote server, the signal comprising data relating to the output of video game content;
the remote server is operable to stream the moving object data but not the video game background data to the client device in response to receiving the signal; and
the processing means is further operable to combine the moving object data and the background data to produce video game content comprising an image in which the one or more objects move and output the video game content to the user via the display means.

56. The network of claim 55, in which the or each moving object is a representation of a three dimensional object, the moving object data comprises a two-dimensional representation of the or each moving object and the remote server is arranged to render the two-dimensional representation from a three-dimensional model.

57. The network of claim 56, in which the video game background data comprises a representation of a background on which the or each moving object moves and the remote server is arranged to render reflections from the background on the or each moving object.

58. A method of providing video game moving object data to a client device via a telecommunications network, the method comprising:
storing moving object data representative of one or more moving objects on a remote server;
streaming the moving object data but not video game background data to the client device in response to receiving a signal relating to the output of video game content.

59. A remote server comprising storage means adapted to store moving object data representative of one or more moving objects of a video game, the remote server being operable to stream the moving object data but not video game background data to a client device via a telecommunications network in response to a signal received from the client device, the signal comprising data relating to the output of video game content.

60. A remote server according to claim 59, the storage means being adapted to store advertisement data representative of at least one advertisement, and the remote server being arranged to streaming the advertisement data to the client device together with the moving object data.

61. A method of providing video game content to a user from a client device, the client device being connected to a remote server via a telecommunications network, the method comprising:
storing video game background data at the client device;
transmitting a signal from the client device, the signal comprising data relating to the output of video game content;
receiving moving object data representative of one or more moving objects streamed from the remote server, the video game background data not being streamed from the remote server to the client device;
combining the moving object data and the background data to produce video game content comprising an image in which the one or more objects move; and
outputting the video game content to the user.

62. A client device comprising user input means, storage means adapted to store video game background data, a network interface and processing means, the processing means being arranged to transmit a signal to a remote server connected via a telecommunications network over the network interface, the signal comprising data relating to the output of video game content;
the network interface being arranged to receive moving object data streamed from the remote server in response to the signal; and
the processing means being arranged to combine the moving object data and the background data to produce video game content comprising an image in which the one or more objects move; and to output the video game content to the user, the video game background data not being streamed from the remote server to the client device.

63. The client device according to claim 62, wherein the video game background data comprises only a portion of the total background data associated with the video game, the processing means being operable to determine whether background data required to be output is stored on the storage means and to transmit a request for background data to the remote server via the network interface in the event that the required background data is determined not to be stored on the storage means.

64. The client device according to claim 62, wherein the network interface is arranged to receive background positioning information together with the moving object data streamed from the remote server, and the processing means is operable to combine the background data and the moving object data in dependence on the background positioning information.

65. A data carrier having computer readable code stored thereon, the code comprising video game background data representative of a background shown during the video game wherein, when the code is run on a suitable processing means, the background data can be combined with streamed moving object data representative of one or more moving objects but not video game background data, to produce video game content comprising an image in which the one or more objects move relative to the background.

66. A method of placing in-game advertisements in video game content provided to the user of a client device, the client device being connected to a remote server via a telecommunications network, the method comprising:
storing video game background data at the client device;
storing moving object data representative of one or more moving objects and advertisement data on the remote server;
transmitting a signal from the client device, the signal comprising data relating to the output of video game content;
streaming the moving object data and the advertisement data but not video game background data from the remote server to the client device in response to receiving the signal;
combining the moving object data and the advertisement data with the background data to produce video game content comprising an image in which the one or more objects move and at least one advert; and
outputting the video game content to the user.

67. The method of claim 66, comprising the step of storing a profile of the user on the remote server, and selecting the advertisement data dependent upon information contained within the profile.

68. The method of claim 66, comprising capturing the user's speech, recognising words or phrases in the user's speech and selecting the advertisement data dependent upon the words or phrases recognised.

69. The method of claim 67, comprising determining the direction of the user's gaze, determining whether the user is looking at the or each advert and recording on the remote server, as part of the profile, which adverts the user has looked at.

70. The method of claim 69, comprising determining the length of time for which a user looks at the or each advert and recording the length of time on the remote server, as part of the profile.

71. The method of any of claim 67, in which the profile contains a list of contacts of the user the method comprising sending advertisements selected dependent upon the information in the user's profile to the user's contacts.

72. The method of claim 71, in which the user's contacts have profiles stored on the storage means of the remote server; the adverts streamed to the user being selected dependent on the content of the user's contacts' profiles.
